(19) United States
(12) Patent Application Publication
(10) Pub. No.: US 2022/0223325 A1
(43) Pub. Date: Jul. 14, 2022

(54) METHOD FOR MANUFACTURING RESISTOR

(71) Applicant: YAGEO CORPORATION, Kaohsiung City (TW)

(72) Inventors: Shen-Li HSIAO, KAOHSIUNG CITY (TW); Ching-Chang LIN, Kaohsiung City (TW); I-Liang SHEN, Kaohsiung City (TW)

(21) Appl. No.: 17/234,820

(22) Filed: Apr. 20, 2021

(30) Foreign Application Priority Data
Jan. 12, 2021 (CN) 202110035245.8

(51) Int. Cl. H01C 17/00; H01C 17/28; H01C 17/065

(52) U.S. Cl. CPC H01C 17/006; H01C 17/065; H01C 17/288

(57) ABSTRACT

A method for manufacturing a resistor is described. First and second division lines are formed in a first surface of a substrate to define device areas. First and second electrodes are formed on the first surface and respectively on the device areas. Third electrodes, fourth electrodes, and resistive layers are formed on a second surface of the substrate and respectively on the device areas. The substrate is diced from the second surface by a cutting tool to form bar structures to expose opposite first and second side surfaces of the device areas. First and second terminal electrodes are formed to respectively cover the first and second side surfaces. The bar structures are diced from the second surface by the cutting tool to separate the device areas. The cutting tool is aligned with the first and second division lines respectively while dicing the substrate and the bar structures.

### RELATED APPLICATIONS

This application claims priority to China Application Serial Number 202110035245.8, filed Jan. 12, 2021, which is herein incorporated by reference.

### BACKGROUND

### Field of Invention

The present invention relates to a technique for manufacturing a passive device, and more particularly to a method for manufacturing a resistor.

### Description of Related Art

In the manufacturing of chip resistance elements, aluminum compounds are typically used as substrates. In the prior art, when a substrate is manufactured, predetermined division lines are formed on a substrate material by punching according to a chip size of a product, and then the substrate material is sintered at a high temperature.

Then, the manufacturer of the resistance element can form an upper electrode, a lower electrode, and a resistive layer of each resistance element on the substrate. The substrate is divided into bar structures along the predetermined division lines, in which the bar structure includes various semi-finished chip resistance elements arranged in a row. Next, terminal electrodes of the chip resistance elements are formed to conduct the upper electrodes and the lower electrodes. Subsequently, the bar structure is diced into individual semi-finished chip resistance elements along the division lines. Then, bonding layers are plated on the semi-finished chip resistance elements to complete the manufacturing of the chip resistance elements.

In the manufacturing of the substrate, the method that forms the predetermined division lines by punching has high production efficiency and low cost, such that the method is widely used by the manufacturers of chip resistance elements. However, in the production method, each substrate has a different shrinkage rate from one another after the substrates are sintered at a high temperature, and thus resulting in slight differences between the sizes of the chip resistance elements. As the size of the chip resistance elements continues to shrink, due to the accumulated tolerance caused by different substrate shrinkage rates, the product sizes of the chip resistance elements are uncontrollable, and even the sizes of some chip resistance elements exceed the specifications.

### SUMMARY

Therefore, one objective of the present disclosure is to provide a method for manufacturing a resistor, which firstly forms division lines in a first surface of a substrate, and cuts the substrate from an opposite second surface of the substrate toward the division lines. The existing of the division line can form a forward stress during cutting, such that a fracture surface of the substrate can be formed to extend toward the division line without chipping off. Accordingly, the size specification of the resistor can be effectively controlled, and the quality and yield of the resistor can be enhanced.

According to the aforementioned objectives, the present disclosure provides a method for manufacturing a resistor. In this method, various first division lines and various second division lines are formed in a first surface of a substrate to define various device areas on the substrate. Various first electrodes and various second electrodes are formed on the first surface of the substrate, in which the first electrodes and the second electrodes are respectively disposed on the device areas. Various third electrodes and various fourth electrodes are formed on a second surface of the substrate, in which the third electrodes and the fourth electrodes are respectively disposed on the device areas. The second surface is opposite to the first surface. Various resistive layers are formed on the second surface of the substrate, in which the resistive layers are disposed on the device areas respectively and correspondingly, and each of the resistive layers is connected to the third electrode and the fourth electrode on the corresponding device area. The substrate is diced from the second surface by using a cutting tool to form various bar structures, so as to expose a first side surface and a second side surface, which are opposite to the each other, of each of the device areas. Dicing the substrate includes aligning the cutting tool with the first division lines respectively. Various first terminal electrodes and various second terminal electrodes are formed to respectively and correspondingly cover the first side surfaces and the second side surfaces of the device areas. Each of the first terminal electrodes connects the first electrode and the third electrode on the corresponding device area. Each of the second terminal electrodes connects the second electrode and the fourth electrode on the corresponding device area. The bar structures are diced from the second surface by using the cutting tool to separate the device areas from each other. Dicing the bar structures includes aligning the cutting tool with the second division lines respectively.

According to one embodiment of the present disclosure, the first division lines and the second division lines are perpendicular to each other.

According to one embodiment of the present disclosure, forming the first division lines and the second division lines includes using laser.

According to one embodiment of the present disclosure, forming the first division lines and the second division lines includes forming various grooves on the first surface of the substrate by using a cutter.

According to one embodiment of the present disclosure, the grooves are V-shaped grooves or arc grooves.

According to one embodiment of the present disclosure, the cutting tool includes a diamond round cutter.

According to one embodiment of the present disclosure, the substrate is a ceramic substrate.

According to the aforementioned objectives, the present disclosure further provides a method for manufacturing a resistor. In this method, various first division lines and various second division lines are formed in a first surface of a substrate, and various third division lines and various fourth division lines are formed in a second surface of the substrate, to define various device areas on the substrate. The third division lines are respectively aligned with the first division lines, and the fourth division lines are respectively aligned with the second division lines. Various first electrodes and various second electrodes are formed on the first surface of the substrate, in which the first electrodes and the second electrodes are respectively disposed on the device areas. Various third electrodes and various fourth electrodes are formed on the second surface of the substrate, in which the third electrodes and the fourth electrodes are respectively disposed on the device areas Various resistive layers are formed on the second surface of the substrate, in which the resistive layers are disposed on the device areas respectively and correspondingly, and each of the resistive layers is connected to the third electrode and the fourth electrode on the corresponding device area. The substrate is diced along the first division lines or the third division lines by using a cutting tool to form various bar structures, so as to expose a first side surface and a second side surface, which are opposite to the each other, of each of the device areas. Various first terminal electrodes and various second terminal electrodes are formed to respectively and correspondingly cover the first side surfaces and the second side surfaces of the device areas. Each of the first terminal electrodes connects the first electrode and the third electrode on the corresponding device area, and each of the second terminal electrodes connects the second electrode and the fourth electrode on the corresponding device area. The bar structures are diced along the second division lines or the fourth division lines by using the cutting tool to separate the device areas from each other.

According to one embodiment of the present disclosure, the first division lines and the second division lines are perpendicular to each other.

According to one embodiment of the present disclosure, forming the first division lines, the second division lines, the third division lines, and the fourth division lines includes using laser.

According to one embodiment of the present disclosure, each of the first division lines, the second division lines, the third division lines, and the fourth division lines is a groove.

According to one embodiment of the present disclosure, the cutting tool includes a diamond round cutter.

According to one embodiment of the present disclosure, the substrate is a ceramic substrate.

### BRIEF DESCRIPTION OF THE DRAWINGS

The aforementioned and other objectives, features, advantages, and embodiments of the present disclosure can be more fully understood by reading the following detailed description of the embodiment, with reference made to the accompanying drawings as follows:

FIG. 1A through FIG. 4A and FIG. 5 are schematic three-dimensional diagrams of various intermediate stages showing a method for manufacturing a resistor in accordance with a first embodiment of the present disclosure;

FIG. 1B through FIG. 4B are schematic partial side views of various intermediate stages showing a method for manufacturing a resistor in accordance with a first embodiment of the present disclosure;

FIG. 6A is a schematic three-dimensional diagram of a substrate for manufacturing a resistor in accordance with a second embodiment of the present disclosure; and

FIG. 6B is a schematic partial side view of a substrate for manufacturing a resistor in accordance with a second embodiment of the present disclosure.

### DETAILED DESCRIPTION

The embodiments of the present disclosure are discussed in detail below. However, it will be appreciated that the embodiments provide many applicable concepts that can be implemented in various specific contents. The embodiments discussed and disclosed are for illustrative purposes only and are not intended to limit the scope of the present disclosure. All of the embodiments of the present disclosure disclose various different features, and these features may be implemented separately or in combination as desired.

In addition, the terms “first”, “second”, and the like, as used herein, are not intended to mean a sequence or order, and are merely used to distinguish elements or operations described in the same technical terms.

The spatial relationship between two elements described in the present disclosure applies not only to the orientation depicted in the drawings, but also to the orientations not represented by the drawings, such as the orientation of the inversion. Furthermore, the terms “connected”, “electrically connected” or the like between two components referred to in the present disclosure are not limited to the direct connection or electrical connection of the two components, and may also include indirect connection or electrical connection as required.

Because the method that forms division lines when manufacturing a substrate causes the difference between the sizes of the resistance elements, and it also causes the resistance elements to not meet the specifications, a laser is used to directly position the substrate and draw predetermined division lines on the substrate and then the resistance elements are peeled and separated, or a cutter is used to directly cut and separate the resistance elements to solve the problem of the difference between the sizes of the substrates. The inventors find that although the two methods can form a substrate with a predetermined size, and can solve the alignment problem in the sequent processes. However, when the two processing methods are used to divide the substrate, the fracture line of the substrate is easy to shift in an uncertain direction during the breaking process of the substrate, thus resulting in cracks or incomplete defects on the fracture surface of the substrate. Such defects are not easy to find, and the defects will not fall off during the subsequent formation of terminal electrodes and the plating of the bonding layer, such that a false attachment may be formed. In the application end, after the resistance element passes through a soldering furnace, a tearing defect is formed between the falsely attached bonding layer and the substrate, such that the resistance element cannot conduct completely, which seriously affects the reliability of the resistance element.

In view of this, the present disclosure provides a method for manufacturing a resistor, which firstly draws predetermined division lines in a first surface of a substrate, and cuts the substrate from an opposite second surface of the substrate toward the division lines. The existing of the division line can form a forward stress during cutting, such that a fracture surface of the substrate can be formed to extend toward the division line without chipping off, thereby enhancing the quality and yield of the resistor.

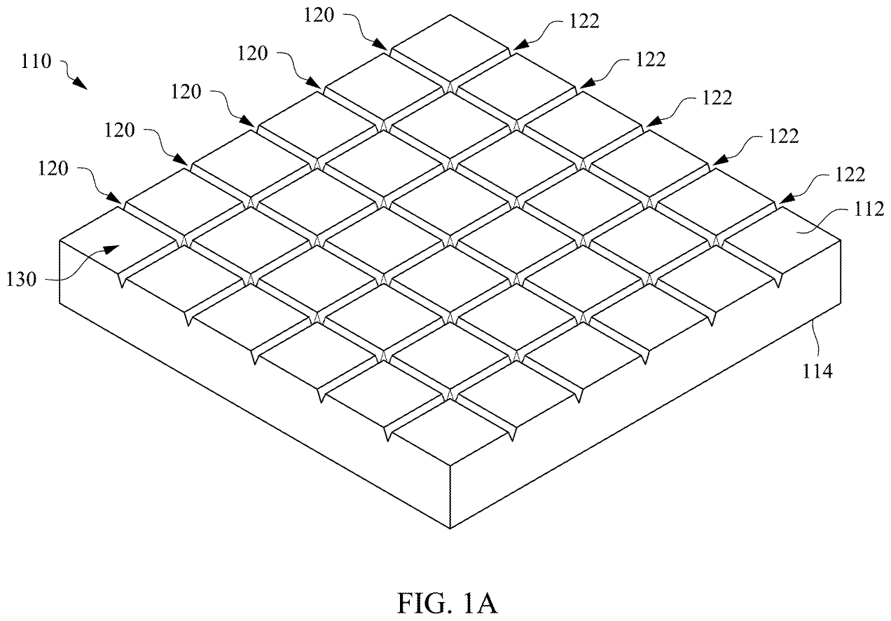

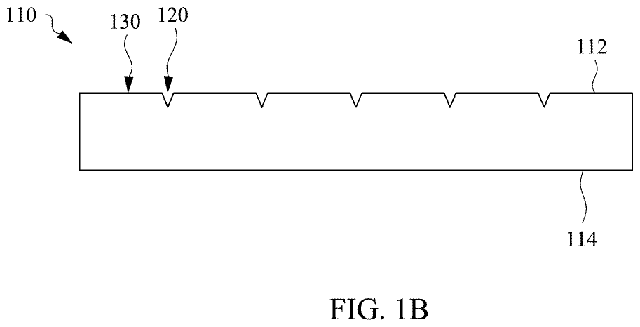

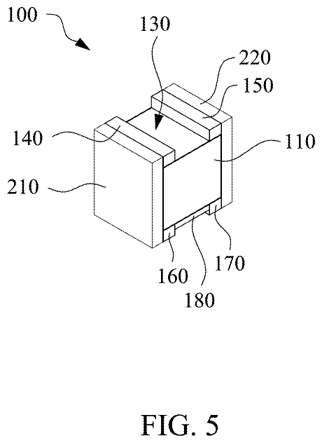

Refer to FIG. 1A through FIG. 4A, FIG. 5, and FIG. 1B through FIG. 4B. FIG. 1A through FIG. 4A and FIG. 5, and FIG. 1B through FIG. 4B are respectively schematic three-dimensional diagrams and schematic partial side views of various intermediate stages showing a method for manufacturing a resistor in accordance with a first embodiment of the present disclosure. In manufacturing of a resistor 100 shown in FIG. 5, a substrate 110 may be provided firstly. The substrate 110 has a first surface 112 and a second surface 114, which are respectively located on two opposite sides of the substrate 110. For example, the first surface 112 of the substrate 110 may be a back surface, and the second surface 114 may be a front surface. The substrate 110 is an insulation substrate, and a material of the substrate 110 may be aluminum oxide (Al₂O₃), for example. In some exemplary examples, the substrate 110 is a ceramic substrate.

Then, as shown in FIG. 1A, various first division lines 120 and various second division lines 122 are formed in the first surface 112 of the substrate 110. In some examples, the first division lines 120 are parallel to each other, and the second division lines 122 are also parallel to each other. In addition, pitches of the first division lines 120 are substantially the same, and pitches of the second division lines 122 are also substantially the same. According to product specifications, the pitches between the first division lines 120 and the pitches between the second division lines 122 may be difference or may be the same. The first division lines 120 intersect the second division lines 122 to define various device areas 130 on the substrate 110. In some exemplary examples, the first division lines 120 and the second division lines 122 are perpendicular to each other, so as to define various rectangular or square device areas 130 on the substrate 110.

In some examples, the first division lines 120 and the second division lines 122 may be drawn in the first surface 112 of the substrate 110 by using a laser. In other examples, the first division lines 120 and the second division lines 122 may be formed in the first surface 112 of the substrate 110 by using a cutter, such as a diamond round cutter. Each of the first division lines 120 and the second division lines 122 may be a groove, such as a V-shaped groove shown in FIG. 1B or an arc groove, formed in the first surface 112 of the substrate 110.

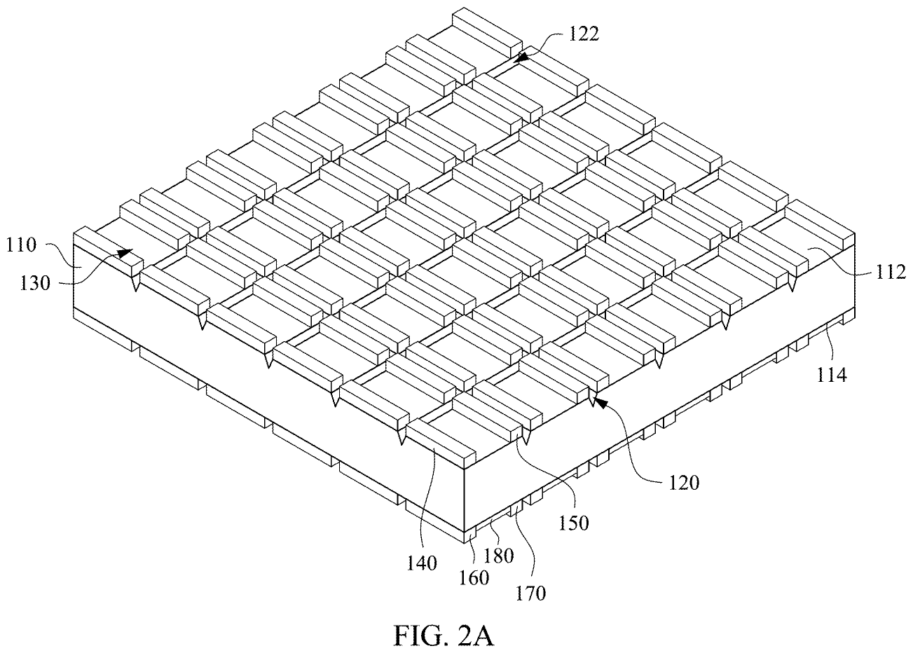

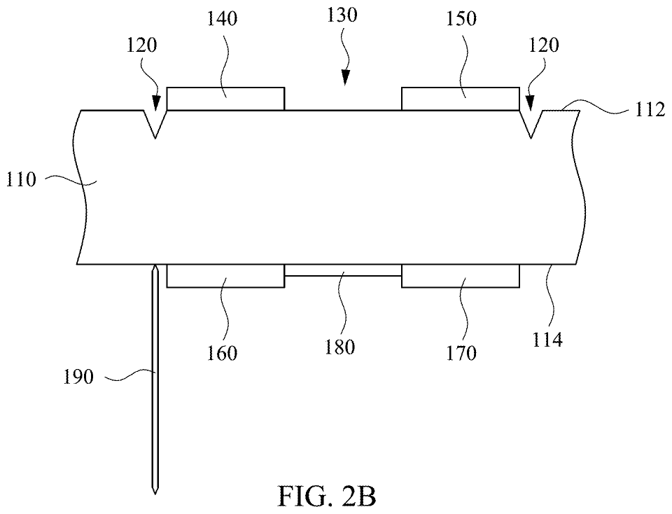

Next, various first electrodes 140 and various second electrodes 150 may be formed on the first surface 112 of the substrate 110 by using, for example, a printing method. The first electrodes 140 and the second electrodes 150 are respectively disposed on the device areas 130, i.e. each of the device areas 130 has one of the first electrodes 140 and one of the second electrodes 150. In each of the device areas 130, the first electrode 140 and the second electrode 150 are separated from each other. For example, as shown in FIG. 2A and FIG. 2B, the first electrode 140 and the second electrode 150 are respectively adjacent to two opposite edges of the device area 130. Materials of the first electrodes140 and the second electrodes 150 may be, for example, copper or silver.

Similarly, various third electrodes 160 and various fourth electrodes 170 may be formed on the second surface 114 of the substrate 110 by using, for example, a printing method. The third electrodes 160 and the fourth electrodes 170 are respectively disposed on the device areas 130, such that each of the device areas 130 has one of the third electrodes 160 and one of the fourth electrodes 170. In each of the device areas 130, the third electrode 160 and the fourth electrode 170 are separated from each other. For example, as shown in FIG. 2A and FIG. 2B, the third electrode 160 and the fourth electrode 170 may be respectively adjacent to two opposite edges of the device area 130, in which a location of the third electrode 160 corresponds to a location of the first electrode 140, and a location of the fourth electrode 170 corresponds to a location of the second electrode 150. Materials of the third electrode 160 and the fourth electrode 170 may be, for example, copper or silver.

In some exemplary examples, the first electrodes 140 and the second electrodes 150, as well as the third electrodes 160 and the fourth electrodes 170 may be formed by respectively printing the materials of the first electrodes 140 and the second electrodes 150, as well as the third electrodes 160 and the fourth electrodes 170 on the first surface 112 and the second surface 114 of the substrate 110, performing a dividing treatment to define patterns, and plastic burning together.

Then, various resistive layers 180 may be formed on the second surface 114 of the substrate 110 by using, for example, a printing method. The resistive layers 180 are disposed on the device areas 130 respectively and correspondingly, such that each of the device areas 130 has one of the resistive layers 180. As shown in FIG. 2B, in each of the device areas 130, the resistive layer 180 may be located between the third electrode 160 and the fourth electrode 170, and connected to the third electrode 160 and the fourth electrode 170.

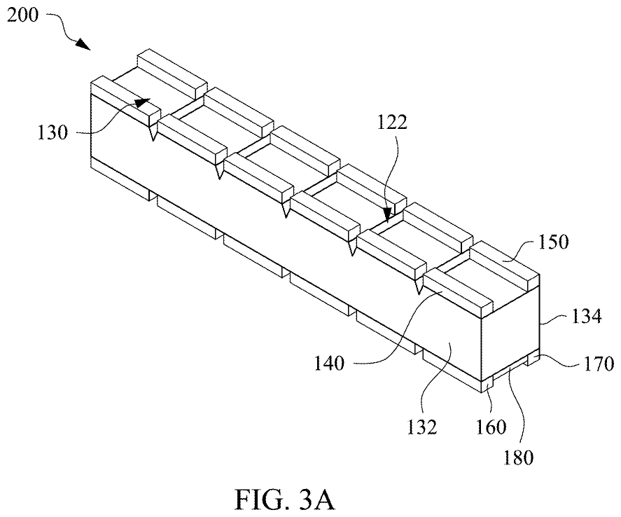

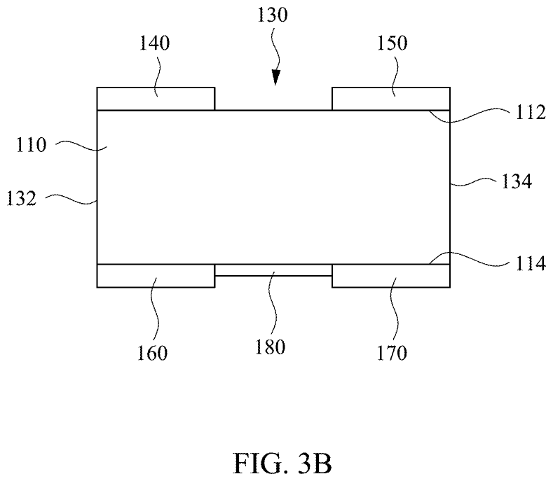

In some examples, after the resistive layers 180 are formed, the substrate 110 may be diced from the second surface 114 by using a cutting tool 190 to form various bar structures 200, as shown in FIG. 3A. In the dicing of the substrate 110 from the second surface 114, the cutting tool 190 is aligned with the first division lines 120 in the first surface 112 to separate bar structures 200 from each other along the first division lines 120. The cutting tool 190 may be a cutter, such as a diamond round cutter. The cutting tool 190 separates the bar structures 200 along the first division lines 120, such that each of the bar structures 200 includes various device areas 130. As shown in FIG. 3B, after dicing, a first side surface 132 and a second side surface 134, which are opposite to each other, of each device area 130 on the bar structure 200 may be exposed. The first side surface 132 and the second side surface 134 both are connected between the first surface 112 and the second surface 114. In addition, the first electrode 140 and the third electrode 160 are adjacent to the first side surface 132, and the second electrode 150 and the fourth electrode 170 are adjacent to the second side surface 134.

The cutting tool 190 is aligned with the first division line 120 for cutting, and the first division line 120 can form a forward stress during cutting, such that a fracture surface of the substrate 110 can be formed to extend toward the first division line 120 without chipping off, thereby enhancing the yield of the cutting process.

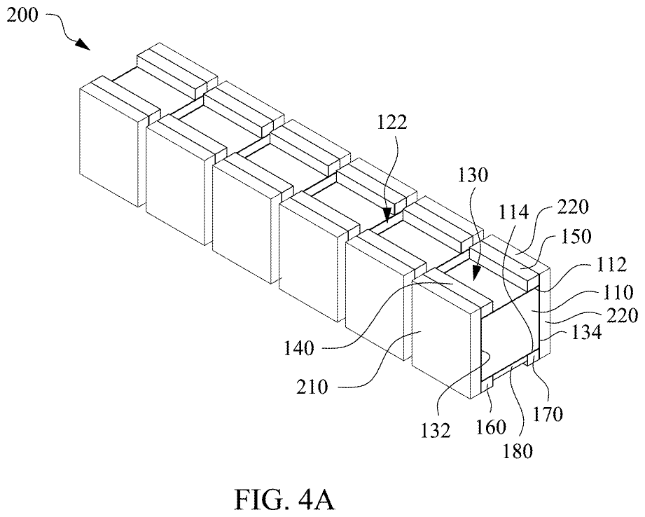

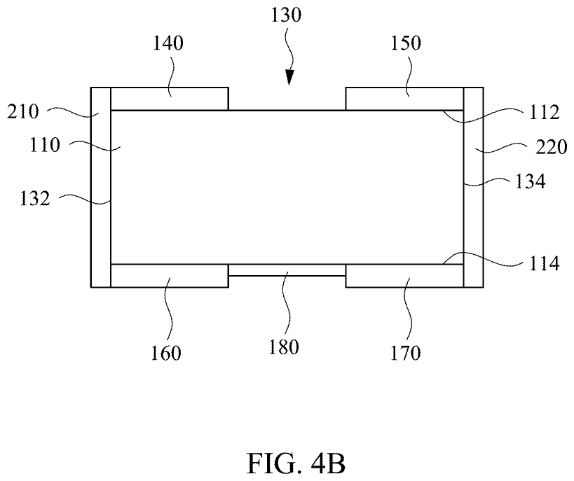

Then, various first terminal electrodes 210 and various second terminal electrodes 220 may be formed by using, for example, a sputtering method. As shown in FIG. 4A and FIG. 4B, the first terminal electrodes 210 respectively cover the first side surfaces 132 of the device areas 130, and are connected to the first electrodes 140 and the third electrodes 160 to electrically connect the first electrodes 140 and the third electrodes 160. The second terminal electrodes 220 respectively cover the second side surfaces 134 of the device areas 130, and are connected to the second electrodes 150 and the fourth electrodes 170 to electrically connect the second electrodes 150 and the fourth electrodes 170. Materials of the first terminal electrodes 210 and the second terminal electrodes 220 may be metal, such as copper or silver.

Next, the bar structures 200 may be diced from the second surface 114 of the substrate 110 by using the cutting tool 190 again to separate the device areas 130 from each other, so as to substantially complete the manufacturing of the resistor 100, as shown in FIG. 5. In the dicing of the bar structures 200 from the second surface 114 of the substrate 110, the cutting tool 190 is aligned with the second division lines 122 in the first surface 112 to divide the device areas 130 from each other along the second division lines 122. The cutting tool 190 is aligned with the second division line 122 for cutting, and the second division line 122 can form a forward stress during cutting similarly, such that a fracture surface of the substrate 110 can be formed to extend toward the second division line 122 without chipping off, thereby enhancing the process yield and quality of the resistor 100.

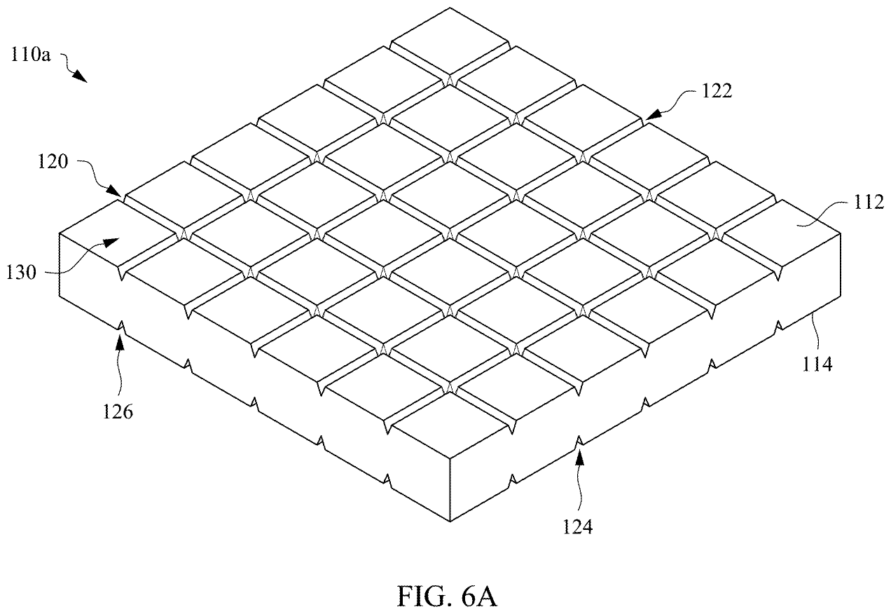

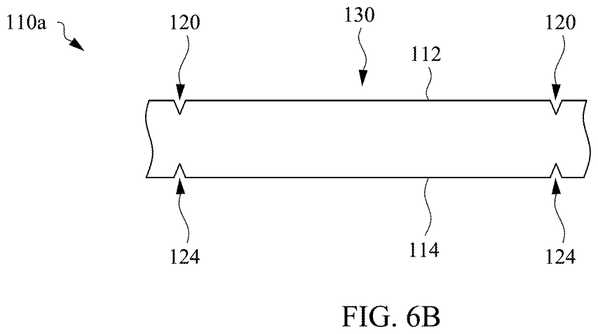

The present disclosure may form division lines on two opposite surface of a substrate. Refer to FIG. 6A and FIG. 6B. FIG. 6A and FIG. 6B respectively illustrate a schematic three-dimensional diagram and a schematic partial side view of a substrate for manufacturing a resistor in accordance with a second embodiment of the present disclosure. In this embodiment, a substrate 110a similarly has a first surface 112 and a second surface 114, which are opposite to each other. The material properties of the substrate 110a may be the same as those of the aforementioned substrate 110.

Various first division lines 120 and various second division lines 122 may be disposed in the surface 112 of the substrate 110a. For example, the first division lines 120 are parallel to each other, and the second division lines 122 are also parallel to each other. Pitches of the first division lines 120 are substantially the same, and pitches of the second division lines 122 are also substantially the same. The first division lines 120 intersect the second division lines 122 to define various device areas 130 on the substrate 110a. For example, the first division lines 120 and the second division lines 122 may be perpendicular to each other.

Various third division lines 124 and various fourth division lines 126 may be further formed in the second surface 114 of the substrate 110a. The third division lines 124 are respectively aligned with the first division lines 120, and the fourth division lines 126 are respectively aligned with the second division lines 122. Thus, the third division lines 124 may be parallel to each other, and the fourth division lines 126 may be parallel to each other. In addition, pitches of the third division lines 124 are substantially the same, and pitches of the fourth division lines 126 are substantially the same. The third division lines 124 intersect the fourth division lines 126, and the third division lines 124 and the fourth division lines 126 may be perpendicular to each other, for example.

A laser or a cutter, such as a diamond round cutter, may be used to form the first division lines 120 and the second division lines 122 in the first surface 112 of the substrate 110a, and the third division lines 124 and the fourth division lines 126 in the second surface 114. The first division lines 120 and the second division lines 122 as well as the third division lines 124 and the fourth division lines 126 may be grooves, such as V-shaped grooves or arc grooves, respectively formed in the first surface 112 and the second surface 114.

The first division lines 120 are respectively aligned with the third division lines 124, such that when the substrate 110a is cut into bar structures, the substrate 110a may be cut from the first surface 112 along the first division lines 120 by using the cutting tool, in some examples. In another examples, the substrate 110a may be cut to form the bar structures from the second surface 114 along the third division lines 124 by using the cutting tool. The second division lines 122 are respectively aligned with the fourth division lines 126, such that when the bar structure is divided into individual resistors, the substrate 110a may be diced from the first surface 112 of the substrate 110a along the second division lines 122, or the substrate 110a may be diced from the second surface 114 along the fourth division lines 126 by using the cutting tool. The cutting tool may be a diamond round cutter, for example.

The structures, the arrangements, the material properties, and the manufacturing methods of the first electrodes, the second electrodes, the third electrodes, the fourth electrodes, the resistive layers, the first terminal electrodes, and the second terminal electrodes may be respectively similar to those of the first electrodes 140, the second electrodes 150, the third electrodes 160, the fourth electrodes 170, the resistive layers 180, the first terminal electrodes 210, and the second terminal electrodes 220, and are not repeated herein.

According to the aforementioned embodiments, one advantage of the present disclosure is that the present disclosure firstly forms division lines in a first surface of a substrate, and cuts the substrate from an opposite second surface of the substrate toward the division lines. The existing of the division line can form a forward stress during cutting, such that a fracture surface of the substrate can be formed to extend toward the division line without chipping off. Therefore, the size specification of the resistor can be effectively controlled, and the quality and yield of the resistor can be enhanced.

Although the present disclosure has been described in considerable details with reference to certain embodiments, the foregoing embodiments of the present disclosure are illustrative of the present disclosure rather than limiting of the present disclosure. It will be apparent to those having ordinary skill in the art that various variations and modifications can be made to the present disclosure without departing from the scope or spirit of the present disclosure. Therefore, the spirit and scope of the appended claims should not be limited to the description of the embodiments contained herein.

What is claimed is:

1. A method for manufacturing a resistor, comprising:
forming a plurality of first division lines and a plurality of second division lines in a first surface of a substrate to define a plurality of device areas on the substrate;
forming a plurality of first electrodes and a plurality of second electrodes on the first surface of the substrate, wherein the first electrodes and the second electrodes are respectively disposed on the device areas;
forming a plurality of third electrodes and a plurality of fourth electrodes on a second surface of the substrate, wherein the third electrodes and the fourth electrodes are respectively disposed on the device areas, and the second surface is opposite to the first surface;
forming a plurality of resistive layers on the second surface of the substrate, wherein the resistive layers are disposed on the device areas respectively and correspondingly, and each of the resistive layers is connected to the third electrode and the fourth electrode on the corresponding device area;
dicing the substrate from the second surface by using a cutting tool to form a plurality of bar structures, so as to expose a first side surface and a second side surface, which are opposite to the each other, of each of the device areas, wherein dicing the substrate comprises aligning the cutting tool with the first division lines respectively;
forming a plurality of first terminal electrodes and a plurality of second terminal electrodes to respectively and correspondingly cover the first side surfaces and the second side surfaces of the device areas, wherein each of the first terminal electrodes connects the first electrode and the third electrode on the corresponding device area, and each of the second terminal electrodes connects the second electrode and the fourth electrode on the corresponding device area; and
dicing the bar structures from the second surface by using the cutting tool to separate the device areas from each other, wherein dicing the bar structures comprises aligning the cutting tool with the second division lines respectively.

2. The method of claim 1, wherein the first division lines and the second division lines are perpendicular to each other.

3. The method of claim 1, wherein forming the first division lines and the second division lines comprises using laser.

4. The method of claim 1, wherein forming the first division lines and the second division lines comprises forming a plurality of grooves on the first surface of the substrate by using a cutter.

5. The method of claim 4, wherein the grooves are a plurality of V-shaped grooves or a plurality of arc grooves.

6. The method of claim 1, wherein the cutting tool comprises a diamond round cutter.

7. The method of claim 1, wherein the substrate is a ceramic substrate.

8. A method for manufacturing a resistor, comprising:
forming a plurality of first division lines and a plurality of second division lines in a first surface of a substrate, and a plurality of third division lines and a plurality of fourth division lines in a second surface of the substrate, to define a plurality of device areas on the substrate, wherein the third division lines are respectively aligned with the first division lines, and the fourth division lines are respectively aligned with the second division lines;
forming a plurality of first electrodes and a plurality of second electrodes on the first surface of the substrate, wherein the first electrodes and the second electrodes are respectively disposed on the device areas;
forming a plurality of third electrodes and a plurality of fourth electrodes on the second surface of the substrate, wherein the third electrodes and the fourth electrodes are respectively disposed on the device areas;
forming a plurality of resistive layers on the second surface of the substrate, wherein the resistive layers are disposed on the device areas respectively and correspondingly, and each of the resistive layers is connected to the third electrode and the fourth electrode on the corresponding device area;
dicing the substrate along the first division lines or the third division lines by using a cutting tool to form a plurality of bar structures, so as to expose a first side surface and a second side surface, which are opposite to the each other, of each of the device areas;
forming a plurality of first terminal electrodes and a plurality of second terminal electrodes to respectively and correspondingly cover the first side surfaces and the second side surfaces of the device areas, wherein each of the first terminal electrodes connects the first electrode and the third electrode on the corresponding device area, and each of the second terminal electrodes connects the second electrode and the fourth electrode on the corresponding device area; and
dicing the bar structures along the second division lines or the fourth division lines by using the cutting tool to separate the device areas from each other.

9. The method of claim 8, wherein the first division lines and the second division lines are perpendicular to each other.

10. The method of claim 8, wherein forming the first division lines, the second division lines, the third division lines, and the fourth division lines comprises using a laser.

11. The method of claim 8, wherein each of the first division lines, the second division lines, the third division lines, and the fourth division lines is a groove.

12. The method of claim 8, wherein the cutting tool comprises a diamond round cutter.

13. The method of claim 8, wherein the substrate is a ceramic substrate.
